(19) United States
(12) Patent Application Publication
(10) Pub. No.: US 2025/0260624 A1
(43) Pub. Date: Aug. 14, 2025

(54) EFFICIENT PACKET DELIMITER (EPD) CONFIGURATION IDENTIFIER FOR MOBILE INDUSTRY PROCESSOR INTERFACE (MIPI) CAMERA SERIAL INTERFACE 2 (CSI-2)

(71) Applicant: QUALCOMM Incorporated, San Diego, CA (US)

(72) Inventors: Nishant JAIN, Noida (IN); Ravi Shankar KADAMBALA, Hyderabad (IN); Ravikishore PAMPANA, Hyderabad (IN)

(21) Appl. No.: 18/439,321

(22) Filed: Feb. 12, 2024

(51) Int. Cl. H04L 41/142; H04L 12/413

(52) U.S. Cl. CPC H04L 41/142; H04L 12/413

(57) ABSTRACT

Aspects of the disclosure are directed to providing high-speed data transport. In accordance with one aspect, the disclosure includes computing a plurality of interpacket gap (IPG) running average values and one or more interpacket gap (IPG) statistics from a count of quantity of spacer code packets in a protocol engine and calculating an efficient packet delimiter (EPD) configuration using the plurality of IPG running average values and the one or more IPG statistics in a data transport protocol controller in the protocol engine.

### TECHNICAL FIELD

This disclosure relates generally to the field of information processing, and, in particular, to high-speed data transport.

### BACKGROUND

In information processing, various high data rate information collected by a plurality of sensors (e.g., camera, audio device, imager, etc.) needs to be aggregated and transported to a host processor for processing and distribution of sensor data to clients. A high-speed sensor data transport protocol may be used to provide high-speed data transport. Configuration settings of the protocol may be selected to balance dc power consumption and data throughput. However, due to non-stationary behavior of the high-speed data transport, it may be difficult to select optimal configuration settings a priori. Therefore, there is a need for a configuration parameter determination for high-speed data transport of sensor data.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides. Accordingly, an apparatus including: an interpacket gap (IPG) calculator configured to compute a plurality of IPG running average values; and an interpacket gap (IPG) configuration parameter calculator unit coupled to the IPC calculator, the IPG configuration parameter calculator unit configured to use the plurality of IPG running average values to calculate one or more IPG statistics.

In one example, the apparatus further includes a PHY protocol interface (PPI) monitor databus coupled to the interpacket gap (IPG) configuration parameter calculator unit, the PPI monitor databus configured to relay the plurality of IPG running average values and the one or more IPG statistics. In one example, the apparatus further includes a data transport protocol controller coupled to the PPI monitor databus, the data transport protocol controller configured to receive the plurality of IPG running average values and the one or more IPG statistics.

In one example, the data transport protocol controller is further configured to calculate an efficient packet delimiter (EPD) configuration based on the plurality of IPG running average values and the one or more IPG statistics. In one example, data transport protocol controller is further configured to use the EPD configuration to specify a data transport protocol. In one example, the data transport protocol controller is further configured to generate a high-speed packet data stream using the data transport protocol. In one example, the apparatus further includes an output PHY protocol interface (PPI), the output PPI configured to transport the high-speed packet data stream.

Another aspect of the disclosure provides a method including: computing a plurality of interpacket gap (IPG) running average values and one or more interpacket gap (IPG) statistics from a count of quantity of spacer code packets in a protocol engine and calculating an efficient packet delimiter (EPD) configuration using the plurality of IPG running average values and the one or more IPG statistics in a data transport protocol controller in the protocol engine.

In one example, the method further includes computing the plurality of IPG running average values based on a quantity of samples that is less than a total quantity of data packets in a high-speed packet data stream. In one example, the method further includes initiating the count of the quantity of spacer code packets being inserted between two consecutive data packets in a high-speed packet data stream at a physical layer interface in the protocol engine.

In one example, the physical layer interface is a PHY protocol interface (PPI) monitor databus. In one example, the method further includes relaying the plurality of IPG running average values and the one or more IPG statistics to the data transport protocol controller in the protocol engine. In one example, the method further includes setting a plurality of efficient packet delimiter (EPD) configuration registers with a maximum EPD value and a minimum EPD value in the protocol engine for one or more input sensor data or an aggregated sensor data.

In one example, the maximum EPD value is set to a maximum hexadecimal value for a N bit register, wherein N is an integer quantity. In one example, the maximum EPD value is selected to allow an application to send a plurality of data packets before a low power (LP) state is reached. In one example, the minimum EPD value is set to a minimum viable interpacket gap duration. In one example, the method further includes pausing for a configurable time duration to allow one or more internal registers of the protocol engine to reach a steady state condition. In one example, the one or more internal registers are the plurality of EPD configuration registers.

In one example, the method further includes enabling an efficient packet delimiter (EPD) configuration identifier module in the protocol engine. In one example, the EPD configuration identifier module includes a plurality of control registers, a bandwidth (BW) calculator, an interpacket gap (IPG) calculator and an interpacket gap (IPG) configuration parameter calculator unit. In one example, the method further includes commencing a reception and an aggregation of the one or more input sensor data from a plurality of sensors to generate the high-speed packet data stream in the protocol engine. In one example, the method further includes using a data transport protocol to generate the high-speed packet data stream. In one example, the data transport protocol is a camera serial interface 2 (CSI2).

Another aspect of the disclosure provides an apparatus including: means for computing a plurality of interpacket gap (IPG) running average values and one or more interpacket gap (IPG) statistics from a count of quantity of spacer code packets in a protocol engine; and means for calculating an efficient packet delimiter (EPD) configuration using the plurality of IPG running average values and the one or more IPG statistics in a data transport protocol controller in the protocol engine.

In one example, the apparatus further includes means for initiating the count of the quantity of spacer code packets being inserted between two consecutive data packets in a high-speed packet data stream at a physical layer interface in the protocol engine. In one example, the apparatus further includes means for relaying the plurality of IPG running average values and the one or more IPG statistics to the data transport protocol controller in the protocol engine.

In one example, the apparatus further includes means for setting a plurality of efficient packet delimiter (EPD) configuration registers with a maximum EPD value and a minimum EPD value in the protocol engine for one or more input sensor data; means for pausing for a configurable time duration to allow one or more internal registers of the protocol engine to reach a steady state condition; means for enabling an efficient packet delimiter (EPD) configuration identifier module in the protocol engine; and means for commencing a reception and an aggregation of the one or more input sensor data from a plurality of sensors to generate the high-speed packet data stream in the protocol engine.

Another aspect of the disclosure provides a non-transitory computer-readable medium storing computer executable code, operable on a device including at least one processor and at least one memory coupled to the at least one processor, wherein the at least one processor is configured to implement high-speed data transport, the computer executable code including: instructions for causing a computer to compute a plurality of interpacket gap (IPG) running average values and one or more interpacket gap (IPG) statistics from a count of quantity of spacer code packets in a protocol engine; and instructions for causing the computer to calculate an efficient packet delimiter (EPD) configuration using the plurality of IPG running average values and the one or more IPG statistics in a data transport protocol controller in the protocol engine. In one example, the non-transitory computer-readable medium further includes instructions for causing the computer to initiate the count of the quantity of spacer code packets being inserted between two consecutive data packets in a high-speed packet data stream at a physical layer interface in the protocol engine.

In one example, the non-transitory computer-readable medium further includes instructions for causing the computer to set a plurality of efficient packet delimiter (EPD) configuration registers with a maximum EPD value and a minimum EPD value in the protocol engine for one or more input sensor data; instructions for causing the computer to pause for a configurable time duration to allow one or more internal registers of the protocol engine to reach a steady state condition; instructions for causing the computer to enable an efficient packet delimiter (EPD) configuration identifier module in the protocol engine; and instructions for causing the computer to commence a reception and an aggregation of the one or more input sensor data from a plurality of sensors to generate the high-speed packet data stream in the protocol engine.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example of packet data transport with deterministic interpacket gaps (IPGs).

FIG. 3 illustrates an example of packet data transport with non-deterministic interpacket gaps (IPGs).

FIG. 4 illustrates an example efficient packet delimiter (EPD) configuration table.

FIG. 5 illustrates an example protocol engine for efficient packet delimiter (EPD) configuration determination.

FIG. 6 illustrates an example programming tasks for interpacket gap (IPG) monitoring preparation.

FIG. 7 illustrates an example flow diagram 700 for efficient packet delimiter (EPD) configuration determination.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may be used to aggregate and process various high data rate information from a plurality of sensors. In one example, a critical part of the information processing system infrastructure is high-speed data transport from the plurality of sensors to a host processor. There are various high-speed data transport protocols available which specify data formats and transmission configuration for the high-speed data transport. One such high-speed data transport protocol for sensor data transport is Camera Serial Interface 2 (CSI-2) by the Mobile Industry Processor Interface (MIPI) alliance. On mobile or other power-limited platforms, selection of transmission configuration is important for balancing of data throughput and dc power consumption (i.e., battery life).

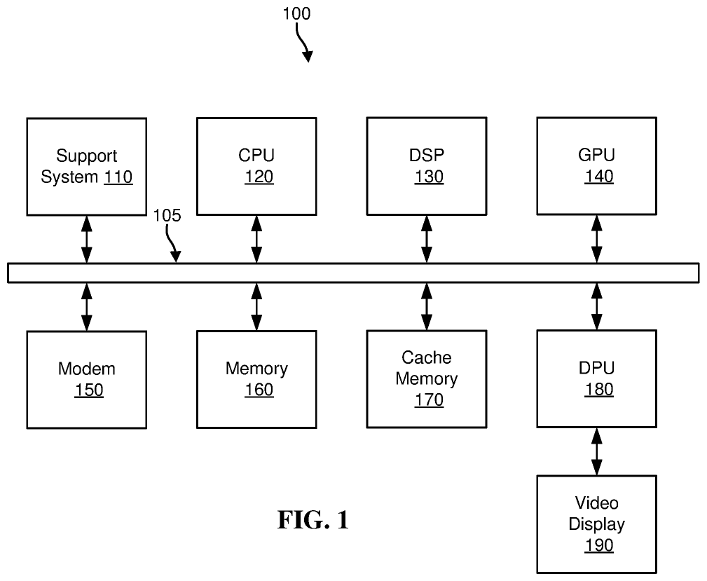

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory which is not shared with the other processing engines.

In one example, selection of transmission configuration to balance data throughput and dc power consumption may be difficult for a real-time video streaming scenario with dynamic video scenes. That is, in a packetized data transport system for dynamic or statistically non-stationary video scenes, the rate of data packet generation may be highly variable over different time scales. In one example, a dynamic video scene may have time-varying video frame rates, where a video frame is a two-dimensional spatial image at a given time. In one example, a statistically non-stationary video scene may have packet generation statistics, (e.g., packet rate mean, packet rate variance, etc.) which are not constant over certain time intervals (i.e., the packet generation statistics are statistically non-stationary). In this scenario, for example, transmission configuration selection may not be performed a priori since data transport behavior may depend highly on a real-time environment. Thus, there is a strong motivation for a transmission configuration selection technique for high-speed data transport which is adaptable in real-time to a dynamic real-time environment.

In one example, many imaging applications which ingest and process sensor data (e.g., camera images or video streams) employ the MIPI CSI-2 protocol for high-speed sensor data transport between a sensor or a plurality of sensors and a host processor or a plurality of processors. For example, the CSI-2 protocol may include two data transfer formats: D-PHY and C-PHY. In one example, the D-PHY data transfer format may include a plurality of data lanes and a single clock lane. In one example, the C-PHY data transfer format may include a plurality of data lanes each with an embedded clock (i.e., there are no separate clock lanes in C-PHY). In one example, a lane is a unidirectional, point-to-point transport interface between a source (e.g., sender) and a destination (e.g., receiver). In one example, the physical layer PHY may be a Camera Serial Interface physical layer (CSI PHY). In another example, the physical layer PHY may be a Mobile Industry Processor Interface Camera Serial Interface physical layer (MIPI CSI PHY).

In one example, a high-speed sensor data transport protocol (e.g., using the CSI-2 protocol) may include a plurality of transmission states, for example, high speed (HS) and low power state (LPS). In one example, the HS transmission state may be used to provide improved data throughput (i.e., to decrease data transport latency) for high speed data packets and the LPS transmission state may be used to provide lower dc power consumption (i.e., to improve battery life). In one example, there may be interleaved HS and LPS transmission states where there is a sequence of HS>LPS>HS transmission states between two high speed data packets, according to the high-speed sensor data transport protocol. For example, the interleaved HS and LPS transmission states minimize dc power consumption but also reduce data throughput. In one example, a time period with no HS data packets present is designated as an interpacket gap (IPG).

In one example, a variety of imaging applications, such as sensor aggregation, machine vision, phase detection autofocus (PDAF), advanced imaging applications, etc. require high data throughput and would benefit from elimination of the sequence of HS>LPS>HS transmission states between two HS data packets.

In one example, for deterministic packet data flows, special data packets such as efficient packet delimiter (EPD) packets or PHY delimiter quick (PDQ) packets may be introduced into a packet data stream to eliminate the sequence of HS>LPS>HS transmission states between two HS data packets deterministically. In one example, protocol-generated spacer code packets may be inserted to eliminate the sequence of HS>LPS>HS transmission states between two HS data packets for interpacket latency management. In one example, a length of a spacer code packet may be equal to an IPG. That is, a longer IPG results in a longer spacer code packet. For example, insertion of spacer code packets may result in a higher dc power consumption and time consumption without precise tuning of a EPD configuration registers. In one example, EPD configuration registers are memory structures which are used to hold EPD configuration parameters. In one example, efficient data transport may be achieved by employing a latency reduction and transport efficiency (LRTE) scheme.

In one example, one critical EPD configuration parameter is EPD_MAX which specifies a maximum number of inserted spacer code packets before transitioning to low power state (LPS). For example, if no new HS data packet is available for transmission when a quantity of inserted spacer code packets equals EPD_MAX, then the transmission state is switched to LPS. For example, if EPD_MAX is not configured optimally, the data transport may incur higher dc power consumption, degraded reliability, under-utilization of EPD capability and software/testing parameter tuning overhead. For example, non-optimal configuration parameter tuning may occur late in a production cycle whereas early optimal configuration parameter setting allows planning and testing advantages.

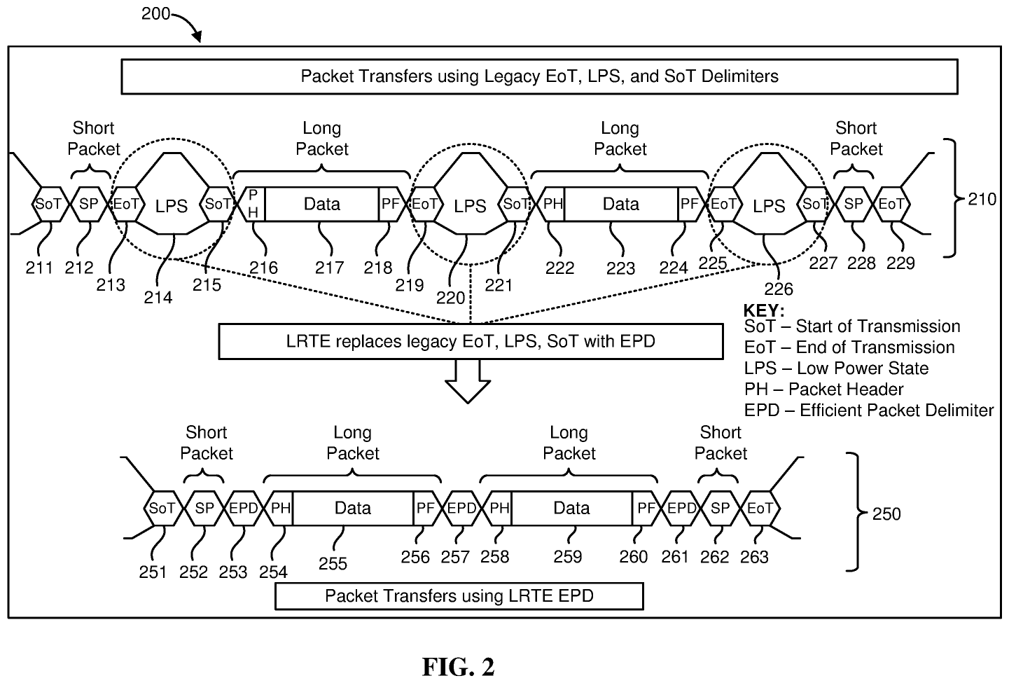

FIG. 2 illustrates an example of packet data transport with deterministic interpacket gaps (IPGs) 200. In one example, a first packet data stream with deterministic IPGs 210 employs legacy packet transport delimiters (e.g., SoT, LPS, EoT, etc.). For example, a first start of transmission (SoT) field 211 is transported first, followed by a first short packet (SP) 212, followed by a first end of transmission (EoT) field 213. Next, a first LPS transition 214 occurs, followed by a second SoT field 215, followed by a first packet header (PH) field 216, a first data field 217, a first packet footer (PF) field 218, and a second SoT field 219. Next, a second LPS transition 220 occurs, followed by a third SoT field 221, followed by a second PH field 222, followed by a second data field 223, followed by a second PF field 224, and a third EoT field 225. Next, a third LPS transition 226 occurs, followed by a fourth SoT field 227, followed by a second SP 228, followed by a fourth EoT field 229.

In one example, a second packet data stream with deterministic IPGs 250 replaces legacy packet transport delimiters (e.g., SoT, LPS, EoT, etc.) with a LRTE scheme using efficient packet delimiter (EPD) packets. For example, a start of transmission (SoT) field 251 is transported first, followed by a first short packet (SP) 252, followed by a first EPD packet 253. Next, a first packet header (PH) field 254 occurs, followed by a first data field 255, followed by a first packet footer field 256. Next, a second EPD packet 257 occurs, followed by a second PH field 258, followed by a second data field 259, followed by a second PF field 260. Next, a third EPD packet 261 occurs, followed by second SP 262, followed by a EoT field 263. In one example, usage of the LRTE scheme using EPD packets for a packet data stream with deterministic IPGs may result in higher data throughput by elimination of the sequence of HS>LPS>HS transmission states.

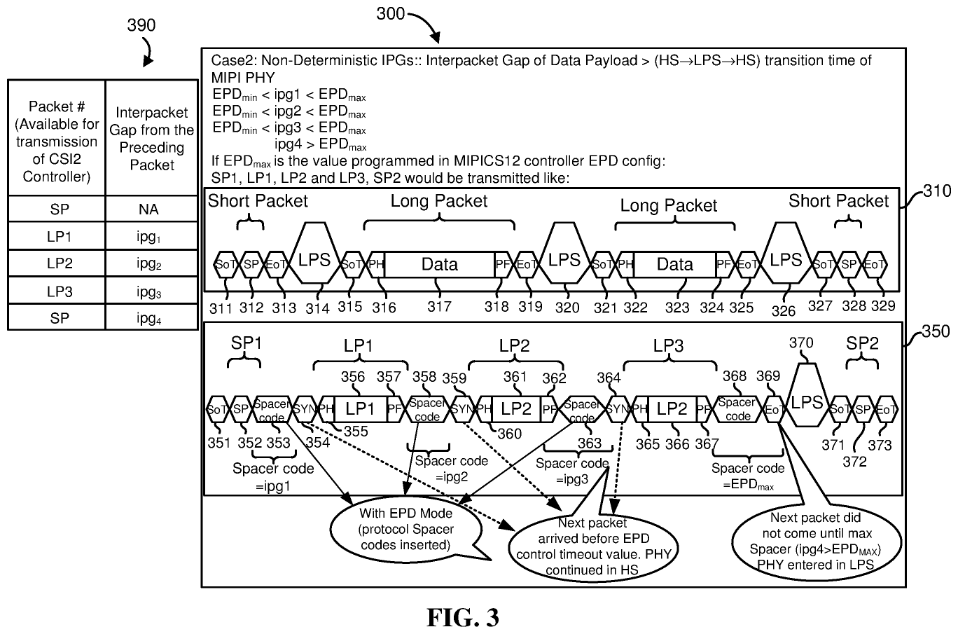

FIG. 3 illustrates an example of packet data transport with non-deterministic interpacket gaps (IPGs) 300. In one example, a first packet data stream with non-deterministic IPGs 310 employs legacy packet transport delimiters (e.g., SoT, LPS, EoT, etc.). For example, a first start of transmission (SoT) field 311 is transported first, followed by a first short packet (SP) 312, followed by a first end of transmission (EoT) field 313. Next, a first LPS transition 314 occurs, followed by a second SoT field 315, followed by a first packet header (PH) field 316, a first data field 317, a first packet footer (PF) field 318, and a second EoT field 319. Next, a second LPS transition 320 occurs, followed by a third SoT field 321, followed by a second PH field 322, followed by a second data field 323, followed by a second PF field 324, and a third EoT field 325. Next, a third LPS transition 326 occurs, followed by a fourth SoT field 327, followed by a second SP 328, followed by a fourth EoT field 329.

In one example, a second packet data stream with non-deterministic IPGs 350 replaces legacy packet transport delimiters (e.g., SoT, LPS, EoT, etc.) with a LRTE scheme using spacer code packets. For example, a first start of transmission (SoT) field 351 is transported first, followed by a first short packet (SP) 352 (SP1), followed by a first spacer code packet 353. In one example, a length of the first spacer code packet 353 is set equal to a first IPG value (IPG1).

Next, a first synchronization (SYN) field 354 occurs, followed by a first packet header (PH) field 355, followed by a first long packet (LP1) data field 356, followed by a first packet footer (PF) field 357, followed by a second spacer code packet 358. In one example, a length of the second spacer code packet 358 is set equal to a second IPG value (IPG2).

Next, a second synchronization (SYN) field 359 occurs, followed by a second PH field 360, followed by a second long packet (LP2) data field 361, followed by a second PF field 362, followed by a third spacer code packet 363. In one example, a length of the third spacer code packet 363 is set equal to a third IPG value (IPG3).

Next, a third synchronization (SYN) field 364 occurs, followed by a third PH field 365, followed by a third long packet (LP3) data field 366, followed by a third PF field 367, followed by a fourth spacer code packet 368. In one example, a length of the fourth spacer code packet 368 is set equal to a maximum EPD value EPD_MAX. In one example, EPD_MAX specifies a maximum number of inserted spacer code packets before transitioning to low power state (LPS). For example, if no new HS data packet is available for transmission when a quantity of inserted spacer code packets equals EPD_MAX, then the transmission state is switched to LPS.

Next, a first end of transmission (EoT) field 369 is transported, followed by a LPS transition 370, followed by a second SoT field 371, followed by a second SP 372 (SP2), followed by a second EoT field 373. In one example, the LPS transition 370 appears since the next packet did not arrive until after an interpacket gap (i.e., IPG4) exceeded the maximum EPD value EPD_MAX.

In one example, an IPG table 390 illustrates a mapping from data packets (e.g., SP1, LP1, LP2, LP3, SP2) to IPG values relative to previous data packets (e.g., N/A, IPG1, IPG2, IPG3, IPG4).

In one example, there may be challenges in optimizing EPD configuration parameters when inserting spacer code packets. For example, EPD configuration parameters are set when spacer code packet insertion is enabled.

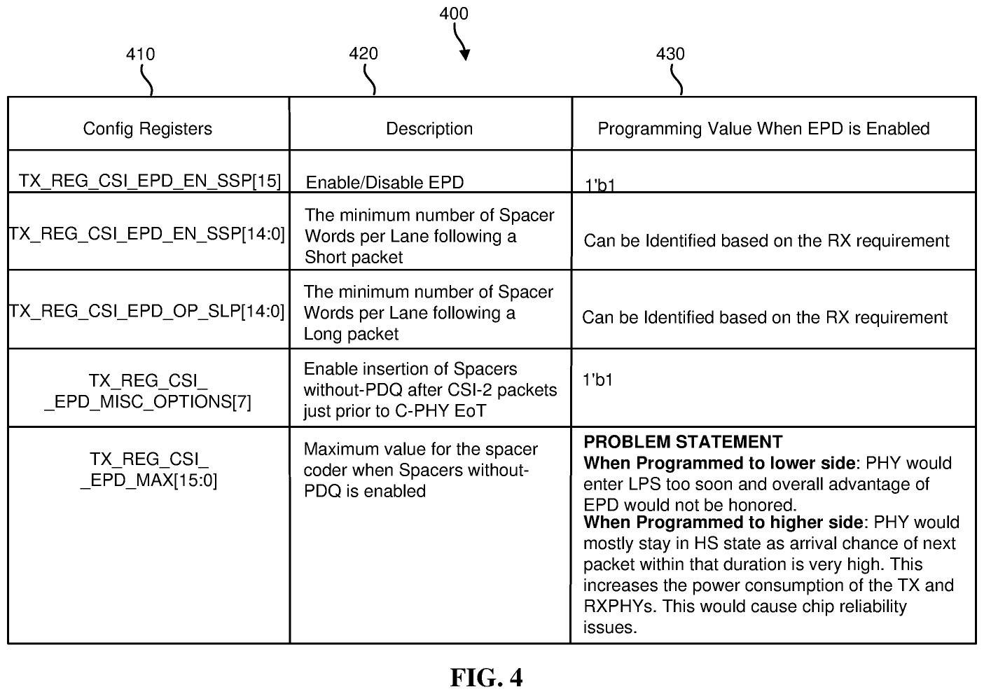

FIG. 4 illustrates an example efficient packet delimiter (EPD) configuration table 400 with a list of configuration registers shown in a first column 410, a description in a second column 420 and a programming value in a third column 430.

In one example, determination of a maximum EPD value EPD_MAX is dependent on use case (e.g., resolution, frame rate, stream quantity, number of bits per pixel, etc.) and on sensor (e.g., camera) type. For example, sensor performance specifications may vary as different sensors may have different sensor parameters such as vertical and horizontal blanking parameters, refresh rates, etc.

In one example, optimization of EPD configuration parameters may be performed using software for precise tuning of the EPD configuration parameters. However, such optimization may be sensor dependent and time consuming. In one example, EPD configuration parameter optimization may occur at a very late product cycle development stage where there is minimal design flexibility available for a true optimization. Moreover, different sensors may not be synchronized for certain collaborative applications (e.g., sensor aggregation). As a result, in one example, aggregated data packets may not have a deterministic interpacket gap (IPG). In one example, a different optimization approach is needed for EPD configuration parameter determination.

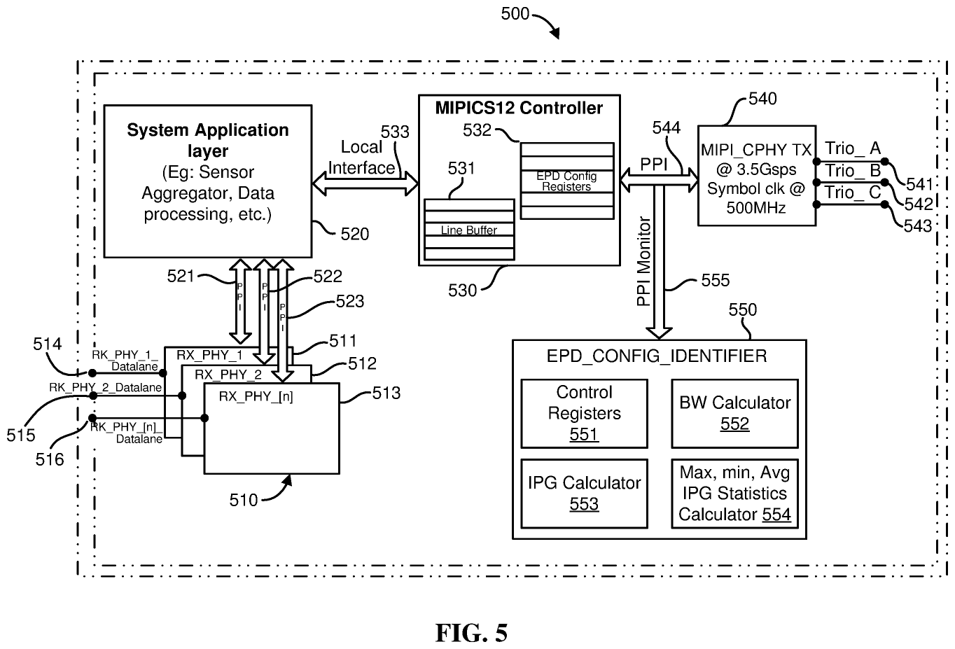

FIG. 5 illustrates an example protocol engine 500 for efficient packet delimiter (EPD) configuration determination. In one example, the example protocol engine 500 includes a plurality of receive physical layer (RX_PHY) modules 510 with a first RX_PHY module 511, a second RX_PHY module 512, etc., and an nth RX_PHY module 513. In one example the plurality of RX_PHY modules 510 receive input sensor data from a plurality of sensors (not shown) via a first RX_PHY data lane 514, a second RX_PHY data lane 515, etc., and an nth RX_PHY data lane 516.

In one example, the plurality of RX_PHY modules 510 send the received input sensor data over a first PHY protocol interface (PPI) 521, a second PPI 522, etc., and an nth PPI 523 to a system application processor 520. In one example, the system application processor 520 performs sensor data aggregation of the received input sensor data and executes a plurality of data processing on the aggregated sensor data to produce a processed aggregated sensor data stream which is transported over a local interface databus 533.

In one example, the processed aggregated sensor data stream is received by a data transport protocol controller 530 using a line buffer memory 531 and a plurality of EPD configuration registers 532. In one example, the data transport protocol controller 530 generates a high-speed packet data stream following a data transport protocol (e.g., CSI2) and delivers the high-speed packet data stream over an output PHY protocol interface (PPI) 544, for example, to a host processor (not shown). In one example, the data transport protocol controller 530 specifies the data transport protocol using an EPD configuration. In one example, the EPD configuration is based on a plurality of IPG running average values and one or more IPG statistics.

In one example, the high-speed packet data stream is received by a transmit physical layer (TX_PHY) module 540 for physical layer transmit processing and production of a plurality of transmit streams over a first transmit interface 541, a second transmit interface 542 and a third transmit interface 543.

In one example, the high-speed packet data stream is also monitored over a PPI monitor databus 555 by an EPD configuration identifier module 550. In one example, the EPD configuration identifier module 550 includes a plurality of control registers 551, a bandwidth (BW) calculator 552, an interpacket gap (IPG) calculator 553 and an interpacket gap (IPG) statistics calculator 554.

In one example, the BW calculator 552 provides a maximum bandwidth achievable using current EPD configuration. In one example, the BW calculator 552 does not participate in IPG measurements. In one example, the IPG calculator 553 provides a spacer code count to compare against a maximum wait time set by current EFD configuration. In one example, the IPG statistics calculator 554 provides IPG statistics of maximum and minimum IPGs incurred during packet transmission and updates in real time according to standard maximum and minimum calculations. In one example, the IPG statistics may be provided using the last 16, 32, or 64 IPGs measured at a current time. In one example, the IPG statistics allow software monitoring of IPG deviation behavior over time (e.g., variation from a mean value).

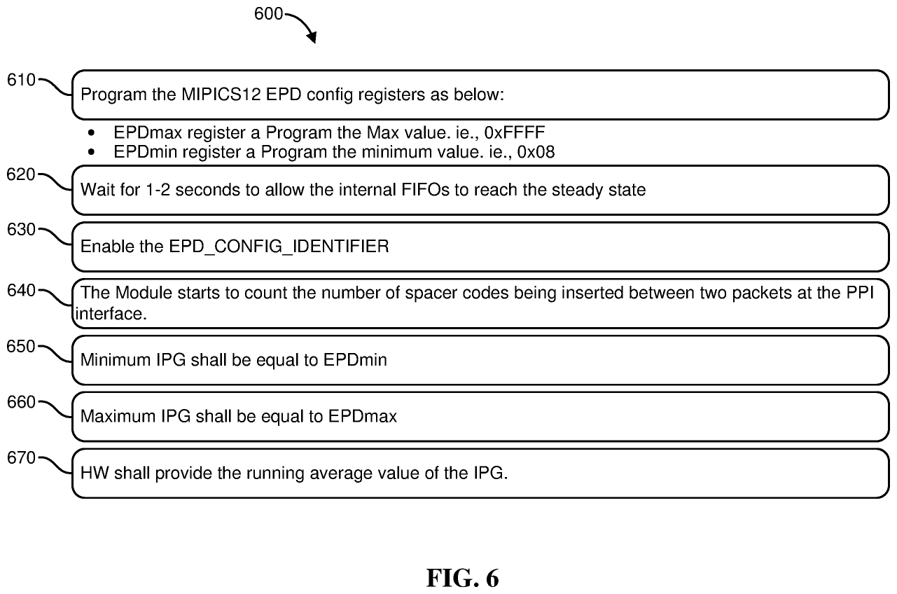

FIG. 6 illustrates an example programming tasks 600 for interpacket gap (IPG) monitoring preparation. In task 610, set a plurality of EPD configuration registers in a protocol engine with a maximum EPD value EPD_MAX and a minimum EPD value EPD_MIN. In one example, EPD_MAX is set to 0xFFFF (i.e., a maximum hexadecimal value for a 16 bit register). In one example, EPD_MIN is set to 0x08 (i.e., a hexadecimal value equal to binary value of 1000 or equal to decimal value of 8). In task 620, pause for a configurable time duration to allow internal registers (e.g., FIFO registers) in the protocol engine to reach a steady state condition. In one example, the configurable time duration is between 1 and 2 seconds. In task 630, enable an EPD configuration identifier module in the protocol engine. In one example, the EPD configuration identifier module includes a plurality of control registers, a BW calculator, an IPG calculator and an IPG configuration parameter calculator unit.

In task 640, initiate counting of a quantity of spacer code packets being inserted between two consecutive data packets at a physical layer interface in the protocol engine from a high-speed packet data stream. In one example, the physical layer interface is a PPI. In task 650, set a minimum IPG value to the minimum EPD value EPD_MIN in the protocol engine. In task 660, set a maximum IPG value to the maximum EPD value EPD_MAX in the protocol engine. In task 670, provide a running average of real-time IPG values from hardware monitoring of the high-speed packet data stream in the protocol engine. In one example, the hardware monitoring is performed using a PPI monitor databus.

In one example, the EPD configuration identifier module detects a packet start boundary and a first spacer code packet by monitoring the high-speed packet data stream. Next, the EPD configuration identifier module counts a quantity of spacer code packets until either a SYN field or an EoT field is detected. In one example, a current IPG value is determined from the quantity of space code packets. If the current IPG value is greater than a current maximum IPG value, then the current maximum IPG value is updated with the current IPG value to produce an updated maximum IPG value. If the current IPG value is less than a current minimum IPG value, then the current minimum IPG value is updated with the current IPG value to produce an updated minimum IPG value.

In one example, the EPD configuration identifier module also computes an IPG running average value from a plurality of IPG values. In one example, the IPG running average value m[k] as a function of discrete time index k may be computed as:

m[k]=(1/M)Σⱼr[k] for j=k−M+1 to j=k
where M=number of samples in running average
r[k]=IPG value at discrete time index k
m[k]=IPG running average value at discrete time index k

That is, in one example, a current IPG running average value at a current discrete time k is based on an average of M most recent IPG values relative to the current discrete time k. In one example, a subsequent IPG running average value at a subsequent discrete time k+1 is based on an average of M most recent IPG values relative to the subsequent discrete time k+1. In one example, a plurality of IPG running average values is transported to a data transport protocol controller with a plurality of EPD configuration registers using the PPI monitor databus. In one example, a plurality of IPG running average values may be computed recursively, i.e., with the subsequent IPG running average value computed based on the current IPG running average value.

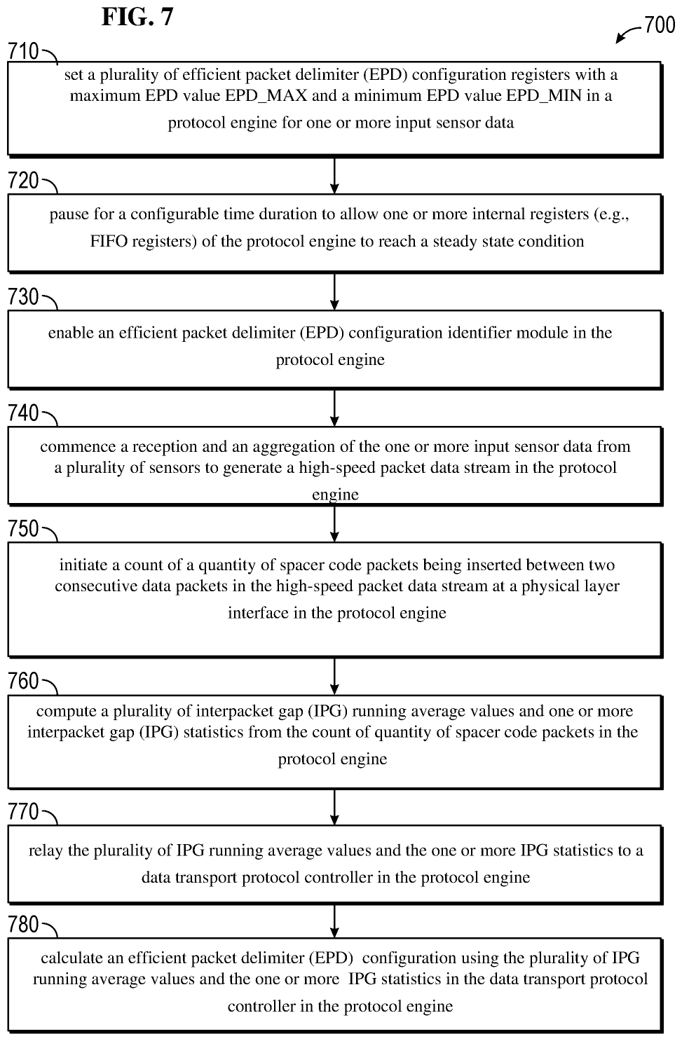

FIG. 7 illustrates an example flow diagram 700 for efficient packet delimiter (EPD) configuration determination. In block 710, set a plurality of efficient packet delimiter (EPD) configuration registers with a maximum EPD value EPD_MAX and a minimum EPD value EPD_MIN in a protocol engine for one or more input sensor data. That is, a plurality of efficient packet delimiter (EPD) configuration registers is set with a maximum EPD value EPD_MAX and a minimum EPD value EPD_MIN in a protocol engine for one or more input sensor data.

In one example, EPD_MAX is set to a maximum hexadecimal value for a N bit register, wherein N is an integer quantity. In one example, N=16 and the maximum hexadecimal value is 0xFFFF. In one example, the maximum EPD value EPD_MAX is selected to allow an application to send a plurality of data packets before a low power (LP) state is reached. In one example, EPD_MIN is set to a minimum viable interpacket gap duration.

In block 720, pause for a configurable time duration to allow one or more internal registers (e.g., FIFO registers) of the protocol engine to reach a steady state condition. That is, a configurable time duration is paused to allow one or more internal registers (e.g., FIFO registers) of the protocol engine to reach a steady state condition. In one example, the internal registers are the plurality of EPD configuration registers. In one example, the configurable time duration is between 1 and 2 seconds. In one example, the internal registers retain the maximum EPD value EPD_MAX and the minimum EPD value EPD_MIN.

In block 730, enable an efficient packet delimiter (EPD) configuration identifier module in the protocol engine. That is, an efficient packet delimiter (EPD) configuration identifier module is enabled in the protocol engine. In one example, the EPD configuration identifier module includes a plurality of control registers, a bandwidth (BW) calculator, an interpacket gap (IPG) calculator and an interpacket gap (IPG) configuration parameter calculator unit.

In block 740, commence a reception and an aggregation of the one or more input sensor data from a plurality of sensors to generate a high-speed packet data stream in the protocol engine. That is, a reception and an aggregation of the one or more input sensor data from a plurality of sensors is commenced to generate a high-speed packet data stream in the protocol engine. In one example, the generation follows a data transport protocol. In one example, the data transport protocol is a camera serial interface 2 (CSI2).

In block 750, initiate a count of a quantity of spacer code packets being inserted between two consecutive data packets in the high-speed packet data stream at a physical layer interface in the protocol engine. That is, a count of a quantity of spacer code packets being inserted between two consecutive data packets in the high-speed packet data stream at a physical layer interface in the protocol engine is initiated. In one example, the physical layer interface is a PHY protocol interface (PPI) monitor databus.

In block 760, compute a plurality of interpacket gap (IPG) running average values and one or more interpacket gap (IPG) statistics from the count of quantity of spacer code packets in the protocol engine. That is, a plurality of interpacket gap (IPG) running average values and one or more interpacket gap (IPG) statistics from the count of quantity of spacer code packets in the protocol engine is computed. In one example, the IPG running average values is based on a quantity of samples M that is less than a total quantity of data packets in the high-speed packet data stream. That is, the computation of the plurality of IPG running average values is based on a quantity of samples that is less than a total quantity of data packets in a high-speed packet data stream. In one example, the one or more IPG statistics include at least one of: a maximum IPG value, a minimum IPG value, a IPG standard deviation, a IPG median, a IPG mode, etc.

In block 770, relay the plurality of IPG running average values and the one or more IPG statistics to a data transport protocol controller in the protocol engine. That is, the plurality of IPG running average values and the one or more IPG statistics are relayed to a data transport protocol controller in the protocol engine. In one example, the plurality of IPG running average values is transported to the data transport protocol controller from the EPD configuration identifier module using the PPI monitor databus.

In block 780, calculate an efficient packet delimiter (EPD) configuration using the plurality of IPG running average values and the one or more IPG statistics in the data transport protocol controller in the protocol engine. That is, an efficient packet delimiter (EPD) configuration is calculated using the plurality of IPG running average values and the one or more IPG statistics in the data transport protocol controller in the protocol engine.

In one example, the calculation uses a statistical model to determine the EPD configuration. In one example, the statistical model uses least squares optimization. In one example, the statistical model uses a linear prediction model. In one example, the statistical model is based on root mean square (RMS) statistics. In one example, the EPD configuration is dynamically computed as a function of discrete time with running average values and other IPG statistics.

In one aspect, one or more of the steps for providing high-speed data transport in FIG. 7 may be executed by one or more processors which may include hardware, software, firmware, etc. The one or more processors, for example, may be used to execute software or firmware needed to perform the steps in the flow diagram of FIG. 7. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
an interpacket gap (IPG) calculator configured to compute a plurality of IPG running average values; and
an interpacket gap (IPG) configuration parameter calculator unit coupled to the IPC calculator, the IPG configuration parameter calculator unit configured to use the plurality of IPG running average values to calculate one or more IPG statistics.

2. The apparatus of claim 1, further comprising a PHY protocol interface (PPI) monitor databus coupled to the interpacket gap (IPG) configuration parameter calculator unit, the PPI monitor databus configured to relay the plurality of IPG running average values and the one or more IPG statistics.

3. The apparatus of claim 2, further comprising a data transport protocol controller coupled to the PPI monitor databus, the data transport protocol controller configured to receive the plurality of IPG running average values and the one or more IPG statistics.

4. The apparatus of claim 3, wherein the data transport protocol controller is further configured to calculate an efficient packet delimiter (EPD) configuration based on the plurality of IPG running average values and the one or more IPG statistics.

5. The apparatus of claim 4, wherein data transport protocol controller is further configured to use the EPD configuration to specify a data transport protocol.

6. The apparatus of claim 5, wherein the data transport protocol controller is further configured to generate a high-speed packet data stream using the data transport protocol.

7. The apparatus of claim 6, further comprising an output PHY protocol interface (PPI), the output PPI configured to transport the high-speed packet data stream.

8. A method comprising:
computing a plurality of interpacket gap (IPG) running average values and one or more interpacket gap (IPG) statistics from a count of quantity of spacer code packets in a protocol engine; and
calculating an efficient packet delimiter (EPD) configuration using the plurality of IPG running average values and the one or more IPG statistics in a data transport protocol controller in the protocol engine.

9. The method of claim 8, further comprising computing the plurality of IPG running average values based on a quantity of samples that is less than a total quantity of data packets in a high-speed packet data stream.

10. The method of claim 8, further comprising initiating the count of the quantity of spacer code packets being inserted between two consecutive data packets in a high-speed packet data stream at a physical layer interface in the protocol engine.

11. The method of claim 10, wherein the physical layer interface is a PHY protocol interface (PPI) monitor databus.

12. The method of claim 10, further comprising relaying the plurality of IPG running average values and the one or more IPG statistics to the data transport protocol controller in the protocol engine.

13. The method of claim 12, further comprising setting a plurality of efficient packet delimiter (EPD) configuration registers with a maximum EPD value and a minimum EPD value in the protocol engine for one or more input sensor data or an aggregated sensor data.

14. The method of claim 13, wherein the maximum EPD value is set to a maximum hexadecimal value for a N bit register, wherein N is an integer quantity.

15. The method of claim 13, wherein the maximum EPD value is selected to allow an application to send a plurality of data packets before a low power (LP) state is reached.

16. The method of claim 13, wherein the minimum EPD value is set to a minimum viable interpacket gap duration.

17. The method of claim 13, further comprising pausing for a configurable time duration to allow one or more internal registers of the protocol engine to reach a steady state condition.

18. The method of claim 17, wherein the one or more internal registers are the plurality of EPD configuration registers.

19. The method of claim 17, further comprising enabling an efficient packet delimiter (EPD) configuration identifier module in the protocol engine.

20. The method of claim 19, wherein the EPD configuration identifier module includes a plurality of control registers, a bandwidth (BW) calculator, an interpacket gap (IPG) calculator and an interpacket gap (IPG) configuration parameter calculator unit.

21. The method of claim 19, further comprising commencing a reception and an aggregation of the one or more input sensor data from a plurality of sensors to generate the high-speed packet data stream in the protocol engine.

22. The method of claim 21, further comprising using a data transport protocol to generate the high-speed packet data stream.

23. The method of claim 22, wherein the data transport protocol is a camera serial interface 2 (CSI2).

24. An apparatus comprising:
means for computing a plurality of interpacket gap (IPG) running average values and one or more interpacket gap (IPG) statistics from a count of quantity of spacer code packets in a protocol engine; and
means for calculating an efficient packet delimiter (EPD) configuration using the plurality of IPG running average values and the one or more IPG statistics in a data transport protocol controller in the protocol engine.

25. The apparatus of claim 24, further comprising means for initiating the count of the quantity of spacer code packets being inserted between two consecutive data packets in a high-speed packet data stream at a physical layer interface in the protocol engine.

26. The apparatus of claim 25, further comprising means for relaying the plurality of IPG running average values and the one or more IPG statistics to the data transport protocol controller in the protocol engine.

27. The apparatus of claim 26, further comprising:
means for setting a plurality of efficient packet delimiter (EPD) configuration registers with a maximum EPD value and a minimum EPD value in the protocol engine for one or more input sensor data;
means for pausing for a configurable time duration to allow one or more internal registers of the protocol engine to reach a steady state condition;
means for enabling an efficient packet delimiter (EPD) configuration identifier module in the protocol engine; and
means for commencing a reception and an aggregation of the one or more input sensor data from a plurality of sensors to generate the high-speed packet data stream in the protocol engine.

28. A non-transitory computer-readable medium storing computer executable code, operable on a device comprising at least one processor and at least one memory coupled to the at least one processor, wherein the at least one processor is configured to implement high-speed data transport, the computer executable code comprising:
instructions for causing a computer to compute a plurality of interpacket gap (IPG) running average values and one or more interpacket gap (IPG) statistics from a count of quantity of spacer code packets in a protocol engine; and
instructions for causing the computer to calculate an efficient packet delimiter (EPD) configuration using the plurality of IPG running average values and the one or more IPG statistics in a data transport protocol controller in the protocol engine.

29. The non-transitory computer-readable medium of claim 28, further comprising instructions for causing the computer to initiate the count of the quantity of spacer code packets being inserted between two consecutive data packets in a high-speed packet data stream at a physical layer interface in the protocol engine.

30. The non-transitory computer-readable medium of claim 29, further comprising:
instructions for causing the computer to set a plurality of efficient packet delimiter (EPD) configuration registers with a maximum EPD value and a minimum EPD value in the protocol engine for one or more input sensor data;
instructions for causing the computer to pause for a configurable time duration to allow one or more internal registers of the protocol engine to reach a steady state condition;
instructions for causing the computer to enable an efficient packet delimiter (EPD) configuration identifier module in the protocol engine; and
instructions for causing the computer to commence a reception and an aggregation of the one or more input sensor data from a plurality of sensors to generate the high-speed packet data stream in the protocol engine.
